(19) United States
(12) Patent Application Publication
(10) Pub. No.: US 2018/0358613 A1
(43) Pub. Date: Dec. 13, 2018

(54) SILICON BASED COMPOSITION FOR A BATTERY AND METHOD FOR MAKING SAME

(71) Applicant: Psycal Energy, Inc., Menlo Park, CA (US)

(72) Inventor: Alper Nese, Menlo Park, CA (US)

(21) Appl. No.: 16/000,065

(22) Filed: Jun. 5, 2018

Related U.S. Application Data
(60) Provisional application No. 62/517,447, filed on Jun. 9, 2017.

(51) Int. Cl. H01M 4/36; H01M 4/38; H01M 4/62; H01M 4/04; H01M 10/0525

(52) U.S. Cl. CPC H01M 4/366; H01M 4/386; H01M 2004/027; H01M 4/049; H01M 10/0525; H01M 4/625

(57) ABSTRACT

The invention is a method for encapsulating an electrochemically active material composition for use in battery electrodes. The active material is coated with a first degradable or otherwise removable polymer material and a second polymer shell prior to removal of the first polymer material. The cavity left by the removal of that first polymer material enables volume expansion and contraction of the active material during battery cycling. Battery anodes including the encapsulated electrochemically active material composition provide greater energy capacity and longevity due to the capsule structure.

This application claims priority from U.S. provisional patent application No. 62/517,447 filed Jun. 9, 2017, which is expressly incorporated herein in its entirety.

### FIELD OF INVENTION

This invention relates to a novel battery electrode composition and method of making same, and in particular, a silicon capsule composition constructed by coating a silicon material with a first layer of a degradable or removable polymer, and adding a second stable polymer to the first layer, prior to removal or degradation of the first polymer layer. The composition allows for volume expansion of the silicon material in the capsule and enhances the energy density of the battery.

### BACKGROUND

Rechargeable lithium ion batteries have been used extensively in consumer electronic products and electric vehicles. The need for improved energy density in those batteries has resulted in a greater focus on electrode structure. Porous structures used in electrodes for primary and secondary batteries exhibit unique physical and chemical properties which traditional bulk materials are unable to achieve. These unique properties provide useful applications with energy storage mechanisms. Porous structures are highly conductive and are comprised of a variety of apertures with pore size ranging from nanometers to micrometers. These microscopic pores provide advantages when used in both batteries and capacitors. Conductive, porous structures are commonly fabricated by infiltrating a porous template with a desired conductive material and subsequent selective removal of the template. Techniques to make such templates include colloidal self-assembly, interference lithography, direct writing of multifunctional inks, direct laser writing in a photoresist, layer by layer stacking of components fabricated by conventional 2D lithography, block co-polymers, and de-alloying. These templates are sacrificial, and varying degrees of order are achieved depending on the fabrication scheme.

However, there are various difficulties when working with porous electrode structures including challenges in creating well-defined pores, efficient and scalable removal of the template in the formation of pores and infiltration of the battery active material. The coating of conventional polymeric foams with metallic materials to make them conductive, while useful for battery electrode designs, significantly increases the cost of the product and decreases the gravimetric energy density of the material due to the high density of the metals. There also are technical challenges in creating homogenously coated materials in a scalable fashion.

Currently, anodes in traditional primary and secondary batteries may be comprised of graphite, which must be used in large quantities to sustain continuous battery cycles. Though useful in lithium-ion batteries for negative electrodes the energy storage for graphite is relatively small at 370 mAh/g. When used with EV (Electric Vehicle) Batteries, there are roughly 55 pounds of graphite needed for a lithium-ion battery. A further drawback of graphite use in traditional battery systems is cost as anode grade graphite is both expensive and leads to excess waste due to the production process of high purity graphite needed in batteries.

Silicon has been used in anodes for lithium-ion batteries, given its substantially higher specific capacity than that for graphite. Each silicon atom can bind up to 4.4 lithium atoms in its fully lithiated state (Li_{4.4}Si), compared to one lithium atom per 6 carbon atoms for the fully lithiated graphite (LiC₆). However, the use of silicon in anodes has been accompanied by undesirable fracturing and crumbling of the silicon material during lithiation when the silicon expands to accommodate the lithium ions. Another issue arising in lithium silicon batteries is the destabilization of the solid electrolyte interface (SEI) layer which results in decreased cell efficiency. The layer, between the electrolyte and the anode, cracks when silicon swells, that results in a thickened layer that consumes lithium and decreases battery capacity.

US20160365573A1 describes the use of a silicon particle coated with a removable block of nickel that has graphene grown on the nickel. After removal of the nickel, there remains a cage of silicon in graphene. However, this method relies upon the use of expensive chemicals and complicated organic reactions, resulting in prohibitive costs for the scaled up manufacture of EV batteries. In particular, the complex manufacturing prevents optimization of the process steps in a reasonable time to allow industrial scale up. Also, while the flexible graphene cage is said to be advantageous for allowing expansion of silicon, the expansion and contraction cycles of the cage can create local mechanical stresses in the coating. Those stresses can lead to cracks in the coating and separation from the anode current collector.

US20160104882A1 describes a process for depositing an active material including silicon in a porous scaffolding matrix. The active material is deposited by gas phase deposition or solution phase infiltrations which are both costly, require significant synthetic steps and are not readily scalable. The later introduction of the active material to an already formed matrix is also inefficient when compared to treating an electrochemically active material to form a suitable anode structure. Gas solid phase reactions are difficult to control in a homogenous way, not easy to scale up, and costly as requiring expensive equipment at high temperatures while resulting in a low yield of depositing gas onto solid surface. Even though solution phase infiltrations avoid the difficulties of gas-solid phase reactions, they still suffer from having a low yield of infiltration, difficulties in controlling the infiltration homogeneity in the matrix, and increased costs due to the excess solvent needed for high dilution.

There remains a need for a cost-effective and scalable solution to the capacity and storage issues posed by the significant volume expansion of silicon that occurs during lithiation.

### SUMMARY OF THE INVENTION

The invention overcomes the limitations of prior lithium-ion battery anodes by providing an encapsulated silicon composition to increase energy output, longevity and capacity of lithium-ion batteries that are lighter, smaller and longer lasting compared to that of traditional graphite-based battery electrodes. The anode contains a silicon-containing capsule dimensioned to enable ample expansion of the silicon during lithiation and coated with a first degradable or soluble polymer, which is later degraded or dissolved in a solvent and removed. A second polymer coating is attached to the first polymer coating, prior to degradation or solvation, and may be later treated to provide it with electrical and ionic conductivity properties. The second polymer coating may also be converted to a carbon material and sealed to prevent electrolyte from entering the capsule.

In an alternative embodiment, an additional layer may be chemically bonded to the second polymer or carbon material coating. Other objects and features of the invention will be apparent in the recitation hereinafter.

### BRIEF DESCRIPTION OF THE DRAWINGS

A more complete understanding of the invention, and the attendant advantages and features thereof, will be more readily understood by reference to the following detailed description when considered in conjunction with the accompanying drawings wherein:

FIG. 1 depicts the stages in the formation of an encapsulated silicon composition, beginning with the coating of silicon material with a middle block polymer that is degradable or otherwise removable by solvation, adding a second outer block polymer coating layer thereto, removal of the middle block polymer by degradation or solvation to form a void within said outer block polymer layer to enable expansion of the silicon material during lithiation, and treating the outer block layer further to form an ionic and electrochemically conductive material.

FIG. 2 depicts the stages in the formation of an alternative embodiment of an encapsulated silicon composition as shown in FIG. 1, wherein an additional layer is applied to the treated outer block polymer layer, after the middle block polymer has been degraded or removed.

FIG. 3 depicts a polymer encapsulated silicon composition of the invention during the cycling stages of battery use, including charge (delithiation) wherein the silicon material expands within the capsule, and discharge (lithiation) wherein the silicon material contracts within the capsule.

### DETAILED DESCRIPTION OF THE INVENTION

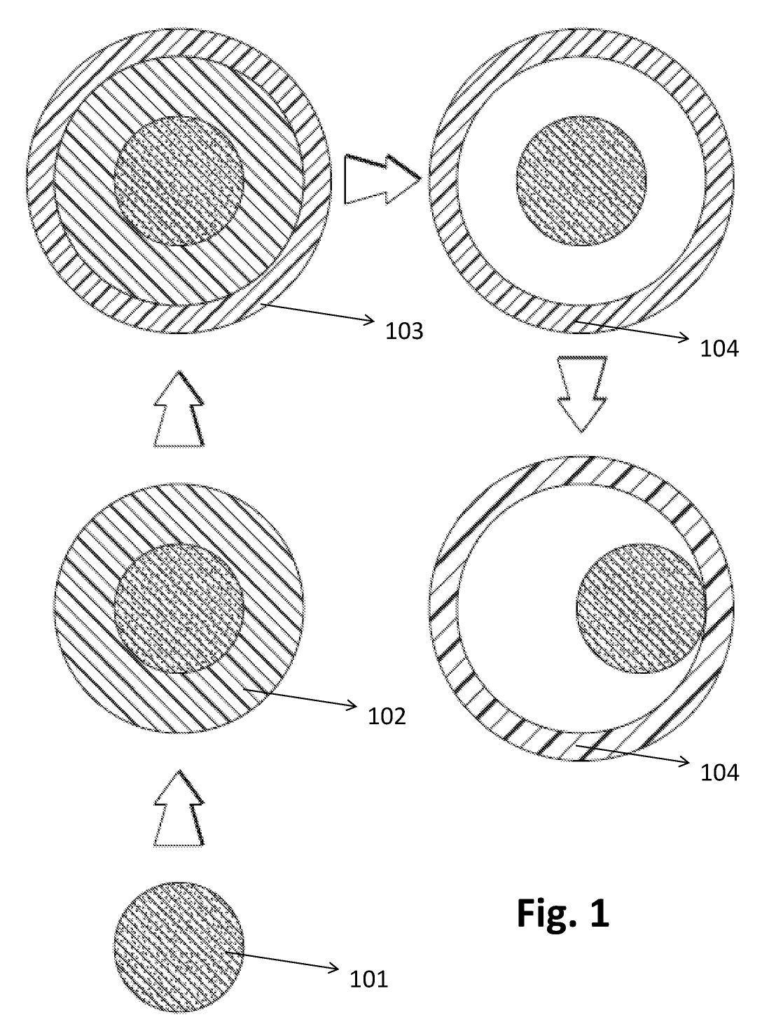

Various embodiments of the novel invention are described herein with details provided for illustration purposes and no unnecessary limitation or inferences are to be understood therefrom. Referring to FIG. 1, the novel anode composition used in rechargeable batteries, such as lithium-ion batteries, comprises a capsule containing an electrochemically active species 101 such as silicon, that is coated with a first polymer 102 that is degradable or later removable by solvent, and a second polymer coating 103 that is retained after the degradation or removal of the first polymer coating. The capsule structure allows for volume expansion of the electrochemically active species during electrochemical oxidation, in the space created by the first polymer degradation and or removal, resulting in enhanced energy density. Preferably, the electrochemically active species used in the capsule is crystalline silicon When crystalline silicon is used as electrochemically active species 101, suitable diameters for the silicon range from 100 nm to 3 um, although other sized particles may be used. While silicon is the preferred electrochemically active species, other suitable electrochemically active species in the capsule include but are not limited to aluminum, tin and antimony. Although other electrochemically active species are suitable, reference to such material as silicon herein should not be viewed as a limitation of this invention.

Degradable or later removable polymer 102 which is used as a first coating of the silicon containing capsule, is also referred to herein as a middle block. Suitable middle block polymers 102 are selected from the group consisting of aliphatic polyesters; polyamides; polyamines; polyalkylene oxalates; poly(anhydrides); polyamidoesters; copoly(ether-esters); poly(carbonates) including tyrosine derived carbonates; poly(hydroxyalkanoates) such as poly(hydroxybutyric acid); poly(hydroxyvaleric acid); and poly(hydroxybutyrate); polyimide carbonates; poly(imino carbonates) such as poly (bisphenol A-iminocarbonate and the like); polyorthoesters; polyoxaesters including those containing amine groups; polyphosphazenes; poly (propylene fumarates); polyurethanes; polymer drugs such as polydiflunisol; polyaspirin; protein therapeutics; biologically modified (e.g., protein; peptide) bioabsorbable polymers; polysilicates; polysiloxanes; and combinations thereof. Other polymers suitable for degradation or later removal by solvation may also be used including but not limited to acrylates, methacrylates, styrenes, acrylonitriles or any other monomers with a polymerization capability. The structure may be modified by using crosslinker units which may be later used for degradation/solvation of the middle block while still providing mechanical integrity prior to subsequent processing steps. Furthermore, other soluble chemicals may be used for this layer of coating. Coating 102 is degradable or removable via solvent treatment and provides a space for silicon to expand during battery operation.

The degradable or removable polymer coating, the middle block, preferably has a thickness in the range of approximately 10 nm to 10 μm, with suitable thicknesses ranging from about 10 nm to about 15 μm. Thicker and thinner coatings may also be possible. Thickness of the middle block coating is determined by the extent of the need for volume expansion of the silicon particles in the capsule during lithiation. One can assume the silicon particle as a sphere and the middle block will be converted into a full space later for silicon to expand. Then it is possible to custom calculate the thickness necessary to accommodate silicon volume expansion on the magnitude of 300% compared to initial volume of the silicon particle. For example, suitable ranges of degradable thickness layer may be from 25 nm to 35 nm when 100 nm diameter silicon particles are used. In another example, if 2 um diameter silicon particles are used, suitable thicknesses of the degradable middle block may range from 500 nm to 650 nm.

Silicon material 101 with first middle block polymer coating 102, is then coated with a second polymer layer 103, also referred to herein as an outer block. Coating layer 103 may be any polymer material providing stable particle structure. This outer block polymer layer should be permeable enough to allow the degradation/removal of the middle block while mechanically strong enough to remain intact surrounding the silicon particles thereafter. The outer block coating may consist of crosslinkable or carbonizeble polymers. The polymers may be prepared by multifunctional monomers or by introducing a crosslinker with monofunctional monomers or a combination thereof. Suitable outer block polymers include polydivinylbenzenes, polyacrylonitriles, polyfluorenes, polyphenylenes, polypyrenes, polyazulenes, polynaphthalenes, polycarbazoles, polyindoles, polyazephines, polythiophenes, polyfurfuryl alcohols, polyanilines, and other aromatic or non-aromatic polymers which provide mechanical integrity while allowing middle block to degradation/removal. Also, the outer block polymer layer may consist of layers of carbon or more specifically graphene. The outer block thickness may range from 1 nm to 1000 nm and preferably from about 50 nm to 100 nm to provide enough mechanical stability while allowing subsequent removal of the middle block.

The outer block layer thickness may be modified depending on the permeability and conductivity of the layer. Furthermore, the outer block layer permeability may be decreased after the removal of the middle block to prevent electrolyte permeation and to further increase the mechanical stability and conductivity. Various chemical reactions can be used to decrease permeability such as polymerization on surface, polymer attachment onto surface, graphene or carbon attachment or formation on the surface as well as other reactions. Referring again to FIG. 1, layer 104 is produced by treating outer layer 103 to create an ionically and electrochemically conductive material with imparted mechanical stability, one illustration of which is discussed in herein.

Degradation of the middle block may be achieved by heating the silicon material with middle block and outer block coating layers, to a high temperature which creates pores in the outer block layer while degrading the middle block layer. The middle block layer should be stable until heated to degradation temperature. Degrading the middle block may also be achieved by reacting the silicon having middle and outer blocks with a liquid that specifically degrades the middle block while leaving the outer block intact. Suitable reactants include acidic solutions, basic solutions, and salt solutions.

Other means for removing the middle block while retaining the outer block encapsulated around the silicon material, include the use of a solvent which dissolves the middle block but only swells the outer block. If the outer block swells sufficiently, solvated middle block polymers may diffuse through the outer block resulting in middle block removal. A wide range of available solvents may be used to remove the middle block polymer and include water, ethanol, methanol, n-propanal, butanol, ether, dicholoromethane, carbon disulphide, glycerol, acetone, carbon tetrachloride, cyclohexane, formic acid, tolune, anisole, pyridine, acetic Acid, hexane, xylene, trifluoroacetic acid, dimethyl sulfoxide, benzene, nitrobenzene, quinoline, dibutyl phthalate, dimethyformamide, cyclohexane, anisole, tetrahydrofuran, combinations thereof and other liquids which dissolve polymers.

Radiation and light may also be used for the degradation of the middle block.

The encapsulated silicon composition is made by viewing the silicon particles as spheres so the thickness of the removable middle block is selected to enable the silicon to expand to up to 3 times its pre-lithiation volume. The expansion occurs in the space vacated by the degraded or removed middle block. This space will accommodate the silicon expansion. The outer layer should be thick enough to provide mechanical stability but thin enough to minimize disadvantages of additional weight. Also, a thinner outer block reduces the existence of impurities which adversely affect the performance of the battery.

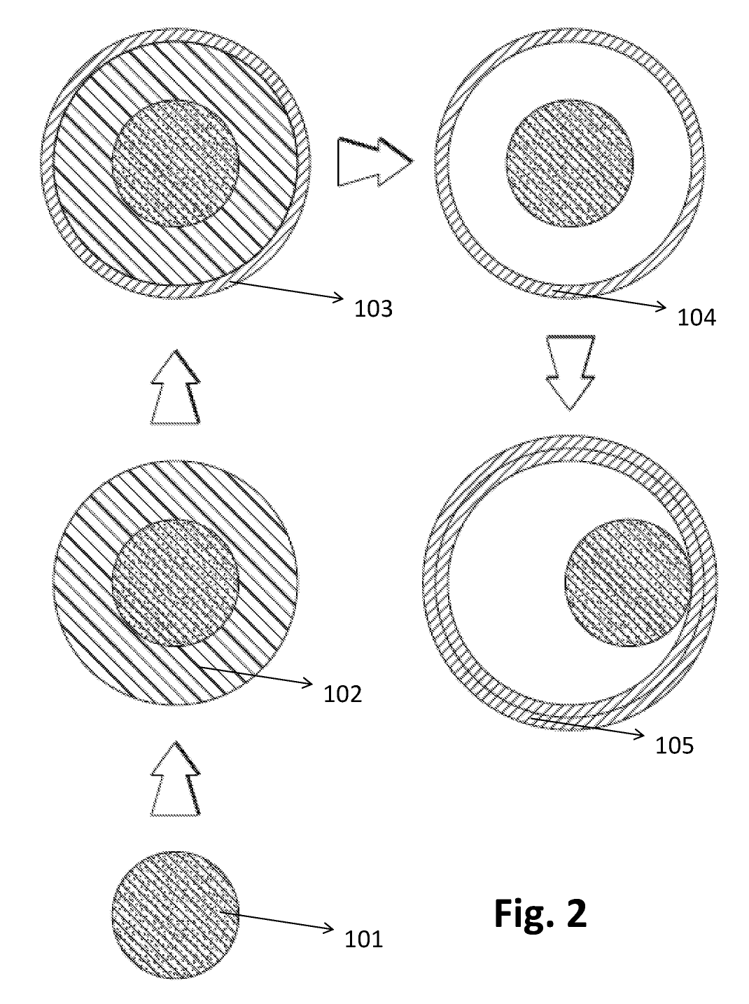

Battery longevity may be controlled by adjusting the degradation rate and the mass of the anode. Usually the mass and thickness of the electrode and the degradation rate of the electrode are correlated as thicker electrodes provide faster degradation. Capacity of the battery depends on the degradation rate of the anode which, in turn, also depends on the surface area exposed to the electrolyte environment. Higher surface area will form more SEI which consumes the lithium irreversibly and contributes to the anode degradation. The surface area of the battery active material, in this case the silicon, may also be adjusted by modifying its shape, and/or providing a coating, to tailor the exposed surface to achieve a slowed or even stopped degradation rate. Such coating may be a soft material such as a polymer that will change its shape with expanding/contracting silicon during battery cycling and protect it from electrolyte degradation and SEI formation. Also, small organic molecules may be attached/adsorbed on the surface of the silicon inside the capsule for same purpose. These small molecules include chemicals with carbon-carbon double bonds, acrylate groups, methacrylate groups, styrenic groups, ester bonds, amine bonds, amide bonds, hydroxy groups, carboxyl groups, silanes, chlorides, bromides, and combinations thereof. Also other chemicals which contribute the polymerization reaction via initiation, propagation, or termination reactions may be used. These chemicals may be in the form of oligomers which promote the adsorption on the silicon surface. Attachment or adsorptions of these chemicals are well known in the literature. Referring to FIG. 2, an additional layer 105 may be attached to layer 104 as described further in [0036] herein.

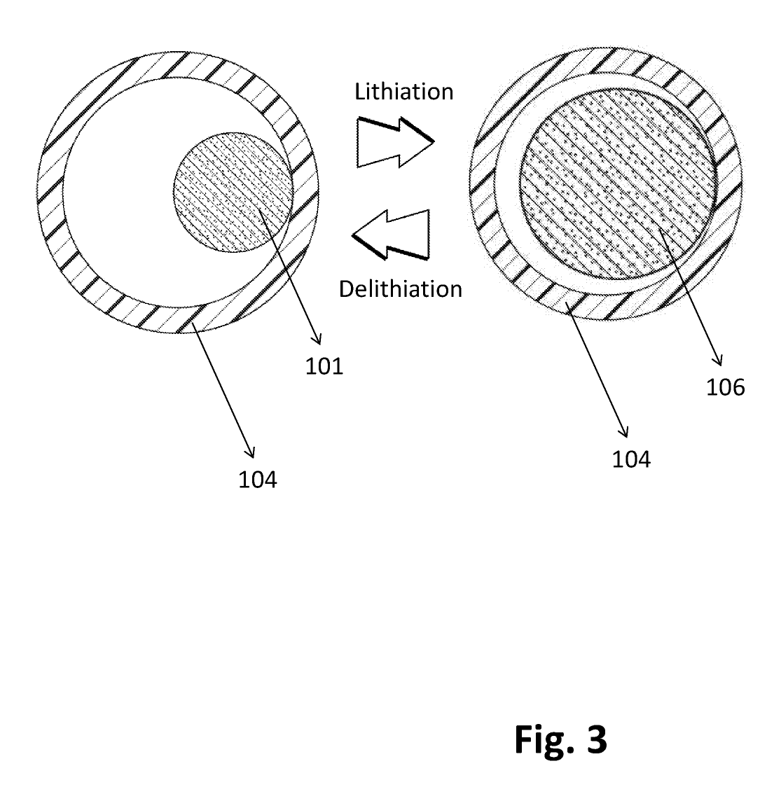

Referring to FIG. 3, an encapsulated electrochemically active species 101 is depicted after removal of a middle block polymer layer with intact layer 104. Expansion of species 101 during lithiation is depicted by lithiated electrochemically active species 106. Layer 104 may be carbon and the carbon encapsulated electrochemically active species may provide an anode energy density of three times that of conventionally used graphite. In maximizing the energy density, consideration should be given to packing density which directly affects the volumetric energy density, as well as the amount of other materials used in the coating, such as conductive additive and binder. The foregoing should be selected so as to avoid diluting the benefit of using the active material such as silicon in the composition described herein.

The encapsulated silicon composition of the present invention may be attached to copper foil conventionally used in lithium-ion batteries by known means. In particular, the silicon composition, in powder form, is mixed with solvent, conductive additive, binder and coated on copper foil to form the anode. Typically the copper foil thickness used as a base for the silicon encapsulated composition of this invention is 10 um. The anode will be used to fabricate a cell by combining it with separator and cathode and electrolyte.

Description of Synthesis of Encapsulated Silicon Composition:

### Step 1, Synthesis of Middle Block on Silicon:

Silicon particles mixed with a solvent and monomer which is a precursor of the polymer middle block to be formed around silicon particle. Monomer will be selected from the list given in [0017]. Silicon particles may be surface modified to improve their dispersibility and/or to have polymerization start on or preferably attach to the silicon particle surface rather than staying in solution. The thickness of the polymer layer can be selected with consideration of the mass ratio of silicon to monomer, reaction time, temperature, and total concentration of all species in the medium. Consumption of all of the monomer in formation of the polymer is preferred. Consequently, the mass of the monomer added can be assumed to form the mass of the middle block. Depending on the polymerization method used, initiator and/or stabilizer may be added. Suitable initiators and stabilizers are well known in the literature. Polymerization may be started by heating the solution to a temperature between 40 C to 200 C. The polymerization reaction may also be performed by light or radiation. In case of light, it is important to stir the reaction mixture vigorously to allow light to be in contact with each part of the solution to provide a homogeneous reaction. Reaction time depends on the nature of the monomer, concentration of the monomer, and other known factors affecting the polymerization rate. A suitable range may be may be from 1 h to 72 hours. Once the reaction is completed, filtration of the polymer coated silicon particles is carried out bypassing the mixture through a filter having pores smaller than the polymer coated silicon particles. Microscopy can be used to observe and measure the thickness of the polymer layer on silicon.

### Step 2, Synthesis of Outer Block on Silicon:

For the second outer block layer preparation, repeat step 1 but substitute monomers chosen from [0019] for the monomers chosen from [0017] and also add the powder formed at the previous step. The obtained material will be a powder with two polymer coatings thereon. Each coating thickness can be in the levels of from tens of nanometers to hundreds of nanometers.

### Step 3, Removal of Middle Block Via Radiation Method:

Removal may be achieved by radiation, heat, solvation or use of reactive solutions. For the radiation method, the powder was exposed to radiation which preferentially degrades the middle block rather than the outer block either in the powder or dispersed in a liquid form. If a powder form is used it is important to form a uniform thickness of powder subjected to radiation to allow homogeneous degradation of the middle block. Also, the atmospheric pressure may be reduced to allow degrading products to leave the medium faster. In addition, it may be necessary to control the atmosphere by choosing gases from a group including nitrogen, argon, oxygen, hydrogen, carbon monoxide, carbon dioxide, air or combinations thereof. If the powder is dispersed in a liquid prior to exposing radiation, a stirring method may be used to provide a homogenous mixture subjected to the radiation

### Step 3, Removal of Middle Block Via Heating Method:

The heating method is done by heating the powder from step 2 in a furnace up to 400 C for several hours. The atmosphere may include nitrogen, argon, oxygen, hydrogen, carbon monoxide, carbon dioxide, air or combinations thereof. The heating will degrade/remove the middle block while forming some small pores in the outer block. It may also change the chemical composition of the outer block and make it more stable. The pores formed at the outer layer may range from 0.1 to 10 nm which provides sufficient space for the evacuation of the small molecules formed as a result of the degradation of the middle block. The duration of the heating will vary depending upon the choice of outer block polymer, the thermal stability of the inner block, the temperature, and pressure, to allow an efficient removal process while keeping the outer block intact.

Step 3, Removal of Middle Block Via Reacting with a Liquid Method:

Reacting with a liquid method involves mixing the powder from step 2 in a reactive liquid which specifically degrades the middle block while swelling or forming small pores in the outer block. In the case of a basic reactant method, the powder from step 2 is added to a sodium hydroxide solution that is prepared in water or in methanol, and then stirred. The time needed to remove the middle block may range from 1 hour to 72 hours although the preferred time is from 12 hours to 24 hours. The temperature of the mixture may be increased up to 150 C to accelerate the degradation process and also to increase the diffusion rate of the degraded products of middle block to outside the capsule.

### Step 3, Removal of Middle Block Via Solvation Method:

For the solvation approach a suitable solvent is used. In one example the powder is dispersed in a solvent and the mixture stirred for a certain time. The stirring time may be from 1 hour to 72 hours. The temperature of the solution may be increased up to 150 C to accelerate the solvation process and also increase the mobility and diffusion of the dissolved polymers to outside the capsule. Use of high amounts of solvent, such as up to 99% of the total mass may be preferred to accelerate the removal process.

Step 4, Modification of Stable Layer:

At this stage the capsule consists of a stable polymer with silicon inside with space defined by the vacated middle block. The outer block may undergo further heating treatment, assuming degradation did not occur by heating in step 3, to modify the stable layer as achieved in step 3-removal of middle block by heating. The powder may be heated up to 950 C under argon, nitrogen, oxygen, hydrogen, carbon monoxide, carbon dioxide, air or combinations thereof for several hours to convert the capsule into a carbon structure. Conversion of the capsule into carbon may occur either due to reaction of the gases present or due to thermodynamic rearrangement and carbonization of the capsule. The carbon part of the polymer may re-organize and form conjugated carbon structures and non-carbon atoms such as hydrogen, oxygen, nitrogen atoms may leave the structure. Converting to carbon allows the capsule to be ionically and electronically conductive and also provides mechanical stability due to superior properties of carbon under stress. At this stage the sample is ready to be tested in the batteries.

### Step 5, Sealing of the Outer Block:

This step involves the sealing of the stable outer block's pores to prevent electrolyte from entering the capsule. Even without this step the material obtained after step 4 is useful, as the capsule will still be electronically and ionically conductive, and the silicon has enough space for expansion so battery cycling can occur. However this step is preferred to seal the pores so that the electrolyte does not penetrate into the capsule. The step also minimizes electrolyte contact on the silicon surface, formation of the solid electrolyte interface and the accompanying irreversible consumption of lithium and decreased capacity during cycling.

Nano-sized graphene pieces sizes ranging from 0.1 nm to tens of nanometers may be reacted with the surface of the capsule to seal outer block pores. Also, capsules may be dispersed in solution and a polymerization reaction may be done in the presence of capsules. Consequently, polymers may form small enough particles to fit in the pores and seal them. In another method carbon can be deposited from gas phase onto and into pores to seal the pores. In another method, graphene can be grown on the surface of pores to seal the pores. Further methods may allow the sealing of pores to prevent electrolyte permeation while still keeping the electronic and ionic conductivity of the outer block. If step 5 is carried out, the resulting powder of encapsulated silicon composition may be used as described in Step 4 to create an anode for use in a lithium-ion battery.

The resulting powder will comprise nanometer or micrometer size particles of a silicon encapsulated composition. The capsule can be visualized by microscopy. The powder may be mixed with solvent, conductive additive, binder and coated on copper foil to form an anode. The anode will be used to fabricate a cell by combining it with a separator and a cathode. Electrolyte will be added and the cell will be tested to see its performance.

It will be appreciated by persons skilled in the art that the embodiments described herein are not limitations of the present invention. While certain novel features of the present invention have been shown and described, it will be understood that various omissions, substitutions and changes in the forms and details of the composition and method for making same can be made by those skilled in the art without departing from the spirit of the invention.

What is claimed is:

1. An encapsulated electrochemically active material composition for use in battery electrodes comprising:
an electrochemically active material;
a shell layer having an outer surface defining an exterior of a capsule and an inner surface defining an internal cavity;
wherein the electrochemically active material is present within a portion of said internal cavity.

2. The composition of claim 1, wherein the electrochemically active material is an anode active material that comprises at least one of silicon, aluminum, tin and antimony.

3. The composition of claim 2 wherein the electrochemically active material is crystalline silicon.

4. The composition of claim 1 wherein the shell layer is a polymer material.

5. The composition of claim 1 wherein the shell layer is a carbon material.

6. The composition of claim 1, wherein the shell layer has a thickness within the range from 1 nm to 1000 nm.

7. The composition of claim 1, wherein the shell layer is electrochemically and ionically active.

8. The composition of claim 1, wherein at least one layer of carbon material is attached to said shell layer.

9. The composition of claim 8, wherein the at least one layer of carbon material is graphene.

10. The composition of claim 3, wherein the diameter of the crystalline silicon is from 100 nm to 3 um.

11. The composition of claim 3, wherein the electrochemically active material has a specific capacity of at least 450 mAh/g when used in a metal ion battery anode.

12. A metal ion battery comprising:
at least one anode comprising the encapsulated electrochemically active material composition of claim 1;
at least one cathode;
an electrolyte enabling transfer of ions between the at least one anode and at least one cathode.

13. The metal ion battery of claim 12 wherein the ions are lithium metal ions.

14. A method of encapsulating an electrochemically active material for use in a lithium-ion battery anode, the method comprising:
coating an electrochemically active material with a first polymer layer;
attaching a second polymer shell layer to said first polymer layer;
degradation or removal of said first polymer layer to form a cavity within said second polymer shell layer that is partially occupied by said electrochemically active material.

15. The method of claim 14 further comprising treating the second polymer shell layer that is partially occupied by said electrochemically active material to render it electrochemically and ionically active.

16. The method of claim 14, wherein the degradation of said first polymer layer is achieved by application of heat.

17. The method of claim 14, wherein the removal of said first polymer layer is achieved by solvating said first polymer layer followed by removal through pores in said second polymer shell layer.

18. The method of claim 14, wherein the electronically active material is silicon.

19. The method of claim 14 further comprising treating the second polymer layer that is partially occupied by said electrochemically active material to form a carbon material.

20. The method of claim 1, further comprising attaching at least one layer of a carbon material to the second polymer shell layer that is partially occupied by said electrochemically active material.
